(19) United States
(12) Patent Application Publication
(10) Pub. No.: US 2026/0267778 A1
(43) Pub. Date: Sep. 10, 2026

(54) MANAGEMENT OF TESTING PROCESS IN A COMMUNICATIONS SYSTEM

(71) Applicant: TELEFONAKTIEBOLAGET LM ERICSSON (PUBL), Stockholm (SE)

(72) Inventors: Sahar TAHVILI, Solna (SE); Albin LÕNNFÄLT, Stockholm (SE); Viktor TU, Stockholm (SE); Animesh SINGH, Stockholm (SE); Yulin CUI, Stockholm (SE); Theofilos TORONIDIS, Sundbyberg (SE); Carlos Valdivia YAGÚE, Stockholm (SE); Akmiel HABTE, Stockholm (SE)

(73) Assignee: TELEFONAKTIEBOLAGET LM ERICSSON (PUBL), Stockholm (SE)

(21) Appl. No.: 19/491,390

(22) PCT Filed: Jun. 13, 2024
(86) PCT No.: PCT/IB2024/055811

§ 371 Date: Dec. 9, 2025

(30) Foreign Application Priority Data
Jun. 14, 2023 (GR) 202330100475

(51) Int. Cl. G06F 11/3668

(52) U.S. Cl. CPC G06F 11/3684; G06F 11/3696

(57) ABSTRACT

A computer-implemented method for management of a testing process in a computing system is provided. The method includes receiving (700) input data including a natural language description for testing of at least one of a functional criteria and a non-functional criteria related to at least a portion of a system under test (SUT). The method further includes, based on the input data, generating (702) with a ML model, at least one of (i) a test process from a plurality of testing processes to perform the testing, and (ii) a mode to perform the test process comprising at least one of automated testing and manual testing; and outputting (704), from the ML model, at least one of (i) the test process to perform the testing, and (ii) the mode to perform the test process.

The present disclosure relates generally to a computer-implemented method performed for management of a testing process in a computing system, and related methods and apparatuses.

### BACKGROUND

Testing of a system under test (SUT), e.g., software, can be a time and resource-consuming process among verification and validation activities and may be considered one of the critical phases in software development life cycles, for example. A software testing process may take up to 50% of the total development cost, for example. See e.g., Tahvili, S., “Multi-Criteria Optimization of System Integration Testing”, Mälardalens University, 2018. SUT testing can be performed manually, semi-automatically, or fully automatically. Generally, there can be four levels of testing, including unit testing, integration testing, system testing, and acceptance testing. For testing a Cloud radio access network (RAN) application, for example, the application may need to be tested in various testing levels and may need to fulfill a range of quality areas. A functional criteria can describe a SUT or a component of the SUT (e.g., inputs, behavior, and/or outputs of the software). A functional criteria can range from the high-level abstract statement of a need from the SUT to detailed textual instructions for the SUT, for example. On the other hand, a non-functional criteria can provide a checklist for important quality attributes related to the SUT, such as security, maintainability, capacity, etc. during the testing process.

### SUMMARY

There currently exist certain challenges. A SUT, such as software, may not satisfy functional and/or non-functional criteria. As a consequence, testing at different levels (e.g., unit testing, integration testing, system testing, acceptance testing, etc.) may need to be performed to determine whether the functional and/or non-functional criteria are satisfied. In some approaches, assigning functional and/or non-functional criteria to different testing levels is a manual test management process that relies on extensive knowledge of the domain. Moreover, existing approaches for test management may lack one or more of the following: handling of non-functional criteria (e.g., such as International Organization for Standardization (ISO) standards); an ability to analyze input data that includes non-controlled natural text (e.g., non-controlled input data describing functional and/or non-functional criteria); and/or an ability to recommend test cases for automated testing. As a consequence, computer-implemented management of testing processes may be lacking that can receive a test request in the form of non-controlled natural language text, divide the non-controlled natural text into different testing levels, and/or while considering fulfillment of non-functional criteria; and identifying automated or manual testing for the different testing levels.

Certain aspects of the disclosure and their embodiments may provide solutions to these or other challenges.

Some embodiments are directed to a computer-implemented method for management of a testing process in a computing system. The method includes receiving input data comprising a natural language description for testing of at least one of a functional criteria and a non-functional criteria related to at least a portion of a SUT. The method further includes, based on the input data, generating with a machine learning, ML, model, at least one of (i) a test process from a plurality of testing processes to perform the testing, and (ii) a mode to perform the test process comprising at least one of automated testing and manual testing. The method further includes outputting, from the ML model, at least one of (i) the test process to perform the testing, and (ii) the mode to perform the test process.

Other embodiments are directed to a computing device for managing a testing process in a computing system. The computing device comprises processing circuitry; and memory coupled with the processing circuitry. The memory includes instructions that when executed by the processing circuitry causes the computing device to perform operations. The operations include to receive input data comprising a natural language description for testing of at least one of a functional criteria and a non-functional criteria related to at least a portion of a SUT. The operations further include, based on the input data, to generate with a ML model, at least one of (i) a test process from a plurality of testing processes to perform the testing, and (ii) a mode to perform the test process comprising at least one of automated testing and manual testing. The operations further include output, from the ML model, at least one of (i) the test process to perform the testing, and (ii) the mode to perform the test process.

In some embodiments, a computing device is configured to manage a testing process in a computing system. The computing device is adapted to perform operations. The operations include to receive input data comprising a natural language description for testing of at least one of a functional criteria and a non-functional criteria related to at least a portion of a SUT. The operations further include, based on the input data, to generate with a ML model, at least one of (i) a test process from a plurality of testing processes to perform the testing, and (ii) a mode to perform the test process comprising at least one of automated testing and manual testing. The operations further include output, from the ML model, at least one of (i) the test process to perform the testing, and (ii) the mode to perform the test process.

In some embodiments, a computer program is provided that includes program code to be executed by a processing circuitry of a computing device configured to manage a testing process in a computing system. Execution of the program code causes the computing device to perform operations. The operations include to receive input data comprising a natural language description for testing of at least one of a functional criteria and a non-functional criteria related to at least a portion of a SUT. The operations further include, based on the input data, to generate with a ML model, at least one of (i) a test process from a plurality of testing processes to perform the testing, and (ii) a mode to perform the test process comprising at least one of automated testing and manual testing. The operations further include output, from the ML model, at least one of (i) the test process to perform the testing, and (ii) the mode to perform the test process.

In some embodiments, a computer program product including a non-transitory storage medium including program code to be executed by processing circuitry of a computing device is provided. Execution of the program code causes the computing device to perform operations. The operations include to receive input data comprising a natural language description for testing of at least one of a functional criteria and a non-functional criteria related to at least a portion of a SUT. The operations further include, based on the input data, to generate with a ML model, at least one of (i) a test process from a plurality of testing processes to perform the testing, and (ii) a mode to perform the test process comprising at least one of automated testing and manual testing. The operations further include output, from the ML model, at least one of (i) the test process to perform the testing, and (ii) the mode to perform the test process.

### BRIEF DESCRIPTION OF DRAWINGS

The accompanying drawings, which are included to provide a further understanding of the disclosure and are incorporated in and constitute a part of this application, illustrate certain non-limiting embodiments of inventive concepts. In the drawings:

FIG. 1 is a schematic diagram that shows an example of a computing device in accordance with some embodiments;

FIG. 2 is a block diagram showing an overview of an example of operations of a computing device for management of a testing process in accordance with some embodiments;

FIG. 3 is a schematic drawing showing an example graphical user interface for inputting data to create a test process of an example embodiment;

FIG. 4 is a schematic diagram showing an example architecture that includes a first ML model for the example embodiment of FIG. 3;

FIG. 5 is a schematic diagram showing an example architecture that includes a second ML model for the example embodiment of FIG. 3;

FIG. 6 is a schematic diagram showing an example for cloud implementation of the computing device in accordance with some embodiments;

FIG. 7 is a flow chart of operations of a computing device in accordance with some embodiments of the present disclosure;

FIG. 8 is a block diagram of an example of a computing system comprising a communication system in accordance with some embodiments;

FIG. 9 is a block diagram of a computing device in accordance with some embodiments;

FIG. 10 is a block diagram of a virtualization environment in accordance with some embodiments;

FIG. 11 illustrates one implementation example for particular embodiments of the present disclosure;

FIG. 12 illustrates an alternative implementation example for particular embodiments of the present disclosure; and

FIG. 13 illustrates three examples of a computing device that may be used to implement particular embodiments of the present disclosure.

### DETAILED DESCRIPTION

Inventive concepts will now be described more fully hereinafter with reference to the accompanying drawings, in which examples of embodiments of inventive concepts are shown. Inventive concepts may, however, be embodied in many different forms and should not be construed as limited to the embodiments set forth herein. Rather, these embodiments are provided so that this disclosure will be thorough and complete, and will fully convey the scope of present inventive concepts to those skilled in the art. It should also be noted that these embodiments are not mutually exclusive. Components from one embodiment may be tacitly assumed to be present/used in another embodiment.

The following description presents some embodiments of the disclosed subject matter. These embodiments are presented as teaching examples and are not to be construed as limiting the scope of the disclosed subject matter. For example, certain details of the described embodiments may be modified, omitted, or expanded upon without departing from the scope of the described subject matter.

While some examples of a test process herein are discussed in the context of a “pipeline” that combines testing functional criteria in different testing levels (e.g., unit level, integration level, system, acceptance level, and acceptance level) and a quality assurance fulfillment for non-functional criteria, the present disclosure is not so limited. Rather, the present disclosure also covers testing scenarios other than pipelines that include testing levels for testing functional criteria alone and/or testing that covers non-functional and/or functional criteria.

Some non-limiting examples herein of a SUT are discussed in the context of a Cloud RAN application. It is noted, however, that the present disclosure is not so limited; and a SUT includes other program code, software, and/or hardware, and other computing/computerized domains.

Generally, a pipeline may be divided into a validation pipeline, a staging pipeline, and an operations pipeline.

A validation pipeline can analyze and verify specific criteria of a particular stage in development of a SUT. A validation pipeline may have a decentralized setup and a technique focus flow, for example. Such a pipeline can be closer to the developers (e.g., software developers) and may cover the lowest test level and SUT. All functional criteria and SUT levels (e.g., software development unit and 2-unit/component or multi-component) may be covered in the validation pipeline. Due to a decentralized setup (e.g., the SUT are different microservices aggregated in the application), for example, complex scenarios cannot be tested in the validation pipeline. The validation pipeline can include both pre-merge and post-merge test activities; and can introduce the need to verify any “legacy” functionality early. In some validation pipelines, the majority of testing functionalities may be executed as close as possible to the team implementing the functionalities. This can include end-to-end systems that have the designers' feedback on real systems (e.g., avoiding submitting code to just receive feedback), digital testing, simulators, unit tests, etc. In addition to fundamental test scenarios, the validation pipeline may cover more advanced test scenarios, such as basic capacity, robustness, and clean carrier tests of short duration and limited functionality, for example.

A staging pipeline can be a near replica of a production environment for SUT testing. Staging environments may be made to test code, builds, and updates to try to ensure quality under a production-like environment before application deployment. A staging pipeline, thus, can be a first step in continuous integration and continuous delivery/continuous deployment (CI/CD) pipelines where SUTs are tested as a whole. In some approaches, different microservices have been tested separately (e.g., as part of the validation pipeline). However, in the staging pipeline, they run simultaneously and interact with each other. Additionally, the scope of the staging pipeline can be divided into two different areas where the scope is executed for each application commit, for example, while a baseline regression scope is executed only daily (e.g., overnight), for example. As a result, the baseline regression scope may not cover a set of commits created since the previous run.

An operations pipeline may detect other issues which may need more complex test scenarios. Thus, an operations pipeline may be more expensive than earlier pipelines (e.g., validation and staging pipelines) but more complete in terms of use-cases by customers. An operations pipeline can have a deployment focus flow. Non-functional criteria should be fulfilled in the operations pipeline. Moreover, an operations pipeline may be centralized (e.g., the SUT is the application). Additionally, an operations pipeline can represent a dynamic pipeline flow builder that is a method of defining and managing CI/CD pipelines using code, rather than using a web-based user interface or other manual configuration, for example. An operations pipeline may provide flexibility for the scope of testing, increased collaboration, reproducibility, automation, version control and compliance, for example.

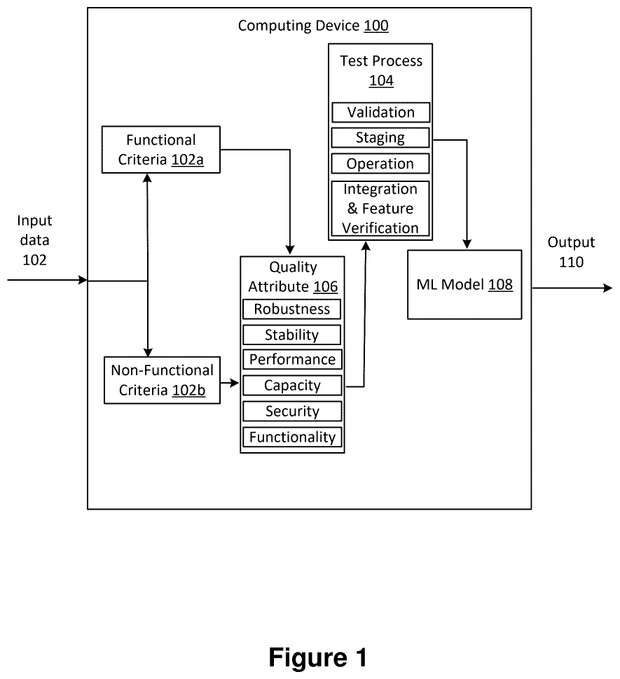

FIG. 1 is a schematic diagram that shows an example of an overview of functional and non-functional criteria management for testing a SUT (e.g., for testing a Cloud RAN application (e.g., a virtualized distributed unit (vDU) or a virtualized central unit (vCU)). A Cloud RAN application, for example, can be complex and different pipelines may need to be defined to test a Cloud RAN application successfully. As shown in FIG. 1, a computing device 100 receives input data 102. The input data includes functional criteria 102a, and non-functional criteria 102b including quality attributes 106 (shown is this example as robustness, stability, performance, capacity, security, functionality). As illustrated in the example of FIG. 1, the functional criteria 102a and the non-functional criteria 102b are both analyzed. The possible testing processes 104 considered in this example include validation, staging, operation, and integration and feature verification. ML model 108 analyzes this information; generates at least one of a test process for the SUT (e.g., software or a feature of software) and a mode to perform the test process (e.g., automated testing or manual testing); and outputs 110 at least one of the test process, the mode, and an automated statement of verification (e.g., verifying fulfillment of the functional criteria 102a and/or non-functional criteria 102b).

Non-functional criteria 102b may be from ISO standards (or other standards). In a non-limiting example, ISO 25010 can be used as non-functional criteria 102b that includes quality attributes for testing a Cloud RAN application. ISO criteria can be certified, although certification is optional. ISO standards (or other standards or specifications), for example, can be used as non-functional criteria 102b by any organization, large or small, regardless of the organization's field of activity.

Functional criteria 102a, however, may be provided by an operator.

Examples herein consider that both functional and non-functional criteria 102 may have a non-controlled natural text format; and that the functional and non-functional criteria 102 may be changed based on a user's needs and requests, considering different regions and quality standards, for example.

In the example for testing of at least a portion of a SUT (e.g., a Cloud RAN application (e.g., vDU, vCU)), a set of functional and non-functional criteria 102a, 102b need to be satisfied. One challenge for releasing a SUT/feature of a SUT (e.g., a Cloud RAN product) faster to the market can be a process of manually assigning different features to different pipelines. Several subject matter experts (SMEs), for example, such as test managers, design teams, and integrators can be involved in this manual process. Existing approaches may introduce problems such as using manual assigning approaches based on existing requirements or the project's demands. Additionally, employing a manual demand-based solution for testing different features of a SUT may be sensitive to product and/or customer changes. Other challenges or problems may include: not covering all features in the testing process; extensive knowledge of the domain may be required; there may be a risk of neglecting quality assurance activities; there may be increased costs and more time spent on product development; customer satisfaction may be decreased; results may be inconsistent; and/or reputational damage may occur as a consequence of a lack of consistent results.

Examples of the present disclosure include an intelligent test management system that automatically captures the input data that includes functional criteria and non-functional criteria, and assigns different features of the input data to different test process (e.g., to different pipelines) considering different non-functional criteria (e.g., different ISO standards).

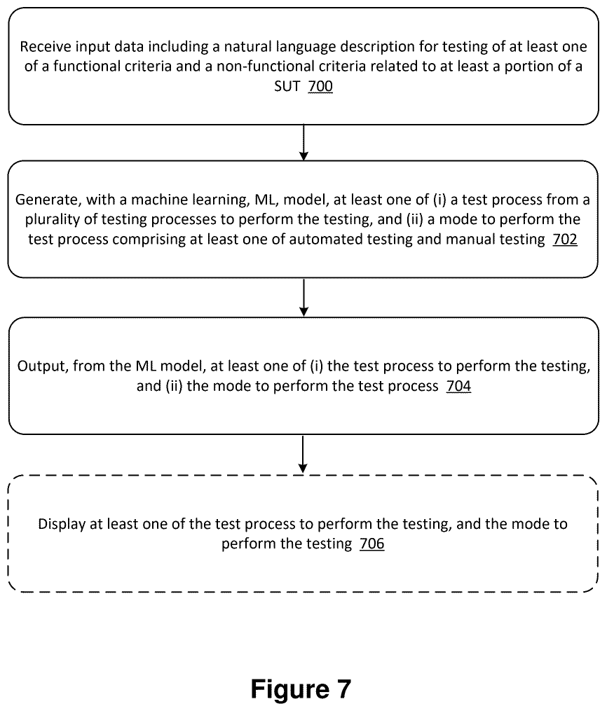

FIG. 7 is a flow chart of operations of a computing device in accordance with some embodiments of the present disclosure. Computing devices herein include, without limitation, a server, a computer, a centralized computing device, a distributed computing device, a cloud-implemented server, and a virtual machine.

Operations of a computing device can be performed by any one of the computing devices 100, 8118, or 9200 shown in FIGS. 1, 8, 9, and 11-13, as discussed further herein. Operations of the computing device (implemented using the structure from any one of FIG. 1, 8, 9, or 11-13) are discussed further herein according to some embodiments of the present disclosure. For example, modules may be stored in at least one memory 9210, 1318, 1348 of FIG. 1, 8, 9, or 11-13, and these modules may provide instructions so that when the instructions of a module are executed by respective computing device processing circuitry 9202, 1312, Or 1342 of FIG. 1, 8, 9, or 11-13, computing device 100, 8118, or 9200 performs respective operations of the flow chart.

Various operations from the flow chart of FIG. 7 may be optional with respect to some embodiments of computing devices and related methods. For example, the operations of block 706 of FIG. 7 may be optional.

As shown in the flow chart of FIG. 7, some embodiments of the present disclosure include a computer-implemented method for management of a testing process in a computing/computerized system. The method includes receiving (700) input data including a natural language description for testing of at least one of a functional criteria and a non-functional criteria related to at least a portion of a SUT. The method further includes, based on the input data, generating (702) with a ML model, at least one of (i) a test process from a plurality of testing processes to perform the testing, and (ii) a mode to perform the test process comprising at least one of automated testing and manual testing; and outputting (704), from the ML model, at least one of (i) the test process to perform the testing, and (ii) the mode to perform the test process.

In some embodiments, the functional criteria includes at least one of a description of a function of at least the portion of the SUT, and a feature of at least the portion of the SUT. The non-functional criteria can include at least one of a quality attribute related to at least the portion of the SUT.

In some embodiments, the test process includes a pipeline and the plurality of testing processes comprise a plurality of different pipelines comprising a validation pipeline, a staging pipeline, and an operations pipeline.

In some embodiments, the test process includes at least a subset of the plurality of testing processes, and a respective test process from the subset is generated and output for respective functional criteria and/or non-functional criteria.

In an example, an intelligent test management system (ITMS) provides recommendations for the classification of test instructions into different CI pipelines and whether these test instructions should be automated. The ITMS in this example includes two machine learning (ML) models: one for the CI pipelines and the other for automation. It is noted that while two ML models are included in this example, the present disclosure is not so limited and can include one ML model or more than two ML models.

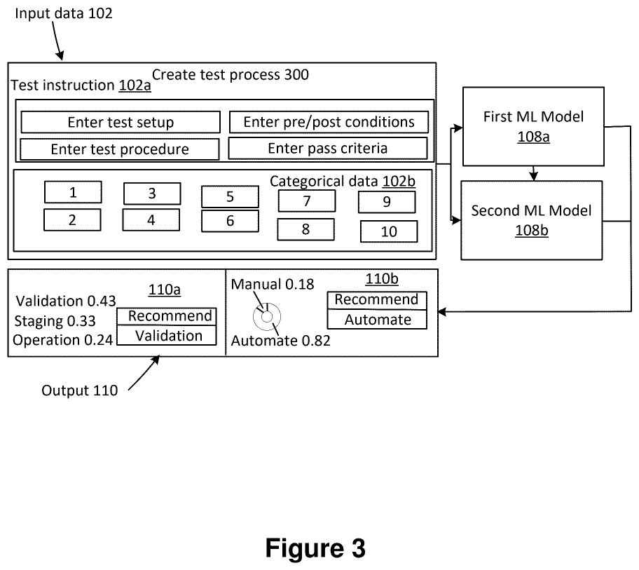

Moreover, the ITMS can have an integrated graphical user interface (GUI) that allows an end user to manually enter input data including details of the test instruction and get recommendations on the CI pipeline and automation on the fly. These recommendations can then be propagated to a general test management system (GTMS) depending on the end user's final decision. While examples herein are discussed in the context of the GUI shown in FIG. 3, the present disclosure is not limited to the GUI representation of FIG. 3 and includes other configurations of an interface for entry of input data that contains a test instruction(s), and outputs a test process and mode.

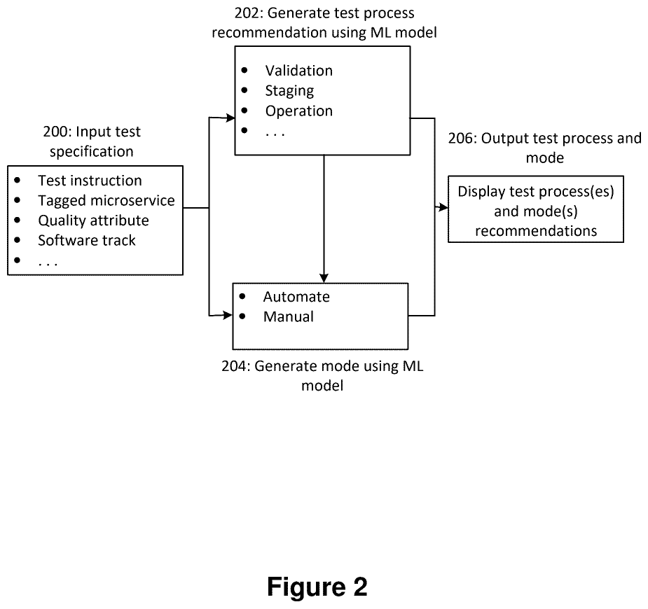

FIG. 2 is a block diagram showing an overview of an example of operations of a computing device 100 for management of a testing process. In operation 200, the computing device 100 receives input data 102 defining a test instruction for testing a SUT or a portion of a SUT (e.g., a feature of software). The input data 102 can include a description of functional criteria 102a (e.g., a test instruction and tagged microservices) and non-functional criteria 102b (e.g., a quality area). As discussed further herein with respect to FIG. 3, a mix of structured natural language and predetermined category options on a GUI can be used to gather the input data needed for the computing device 100 to output 110 a recommend CI pipeline and whether the test instruction is suitable for automation.

In operation 202, computing device 100 generates a test process recommendation using ML model 108. The test instruction is used in this example to recommend a CI pipeline for the specific test case. As discussed herein, for testing a Cloud RAN application, different CI pipelines (e.g., pipeline 1, pipeline 2, pipeline 3), which are a collection of characteristics specified in the ISO 25010 standard, can be employed. Classifying the CI pipeline for a test case, therefore, can indirectly predict which parts of the ISO 25010 standard will be covered. Table 1 shows and example of mapping of ISO 25010 characteristics to CI pipelines 1, 2, and 3:

| CI Pipeline | ISO 25010 Characteristics |
|---|---|
| Pipeline 1 | Robustness, Stability, Traffic, Performance, |
| | Capacity, Upgrade, Portability (including |
| | Adaptability, Installability, Co-Existence) |
| Pipeline 2 | Upgrade, System Operation, Robustness, |
| | Traffic Functionality, Performance, |
| | Security |
| Pipeline 3 | Stability, Traffic Functionality, Capacity, |
| | Main Processor and Overload, |
| | Performance: Accessibility, Mobility and |
| | Integrity, Robustness and Resilience, |
| | Maintainability (including Modularity, |
| | Testability, Reusability) |

In some embodiments, generating (operation 702 of FIG. 7) includes using the ML model to analyze semantics of at least the natural language description to classify a test process, and to determine a statistical distribution of words in the natural language description to identify the test process.

The ML model can include a first ML model including a rule-based component to analyze a length of the natural language description, and a first plurality of sub-models to generate the test process. The first plurality of sub-models can include a first sub-model including a semantic classification model to output a semantic meaning of the natural language description. A second sub-model can include a word-distribution classification model to output a statistical distribution of words in the natural language description. The first ML model can receive at least the output of the semantic classification model and the word-distribution classification model to classify and output the test process.

The rule-based component can determine a number of characters in the natural language description and use a plurality of rules to assign the natural language description to a test process based on the number of characters.

In some embodiments, the input data further includes the natural language description distributed among a plurality of test instructions; and the semantic classification model converts the natural language description distributed among the plurality of test instructions to word embeddings, and outputs a classification of the natural language description per test instruction into an outputted test process from the plurality of test processes.

For example, continuing with the above example of FIG. 2, the classification is accomplished by using different supervised ML approaches. ML model 108, in this example, includes a first ML model 108a for the CI pipeline that includes a rule-based component and three sub-models that are integrated into an ensemble architecture. The rule-based component analyzes the length of the test instruction and overrules the sub-models for given situations. The three sub-models can be categorized into natural language-based and categorical-based sub-models:
Natural language-based sub models: analyze the semantics of test instructions to classify the CI pipeline; and utilize Bayesian statistics of words in the test instruction.
Categorical-based sub model: Uses a classification algorithm on categorical data from the test instruction.

Test scope functionalities and applications (e.g., in Cloud RAN) can vary and, thus, in this example, test coverage is split into three pipelines of different scopes. It is noted, however, that for different SUTs and/or different domains, a different number or type of test processes may be applicable.

In operation 204, computing device 100 generates a mode (e.g., automatic or manual) using a second ML model 108b. The second ML model 108b uses an ensemble model that utilizes two sub-models to generate the mode (e.g., automation recommendations). The first sub-model of ML model 108b uses a semantic representation of the description of the test instruction. The second sub-model of ML model 108b uses categorical data (e.g., artifacts) from the test instruction and the recommended CI pipeline provided by the first ML model 108a for CI pipeline in operation 202 to determine whether a test case can be automated. For this task, in this example, supervised learning is used.

In operation 206, computing device 100 outputs 110 the test process and the mode. The output 110, optionally, can be displayed. Output 110 can include a recommendation that can later serve as a decision support tool when assigning test cases to CI pipelines and deciding whether a test case should be automated. This decision support can be integrated into the operational process, which may enable decision-makers to improve the efficiency of the task and minimize a number of misclassifications.

By leveraging the recommendation generated by computing device 100, decision-makers may better allocate their time and resources, resulting in a more streamlined and effective testing process. This, in turn, can lead to a faster and more reliable SUT development lifecycle.

FIG. 3 is a schematic drawing showing an example GUI for inputting data 102 to create a test process 300. The GUI, in this example, is implemented as a web portal written in Java-script, HTML, Python and CSS, for example. As shown in FIG. 3, this example GUI includes section 102a to input a test instruction for the SUT or a portion of the SUT (e.g., a feature) to be tested. Section 102a can include required and optional data. Optional data can include, e.g., a name of the end user entering the input data 102; and required data can include the test instruction. The data in Section 102 (a) can further include categorical data (e.g., artifacts) from the test instruction.

Although the end user can enter this information as free-form text, the GUI can include information to guide an end user to provide the information in a structured manner. For example, the test instruction can be divided into subparts on the GUI with prompts to the end user to enter input data 102a into separate text boxes which can include, for example, separate text boxes with respective prompts to the end user to enter natural language descriptions of a test setup, pre/post-conditions, test procedure, and pass criteria, respectively. The combination of structured data input and free-form text collection in the GUI may allow ML model 108 to learn more efficiently, while also providing flexibility to fully express test instructions.

The example GUI also includes section 102b where the end user inputs categories of data 102b. The categories of data 102b can include, for example, a quality area, a software track, and a tagged microservice. Some, or all, categories may be selected by the end user from a predetermined drop down menu, for example. However, some categories may have a large set of possible options or are of a dynamic nature where the categories are subject to change over time. For such categories, section 102b of the GUI may include a portion where the end user inputs the data 102b in free text without any limitations. To ensure compatibility of the free text input with the categorical nature, comprehensive data processing may be implemented.

In some embodiments, the method further includes displaying (operation 706 in FIG. 7) at least one of the test process to perform the testing, and the mode to perform the testing. Displaying (706) can further include displaying a first confidence level for the test process and a second confidence level for the mode.

The example GUI further includes sections 110a and 110b where a test process and mode of the output 110 is shown. Section 110a of this example includes a display of the three pipelines, a corresponding confidence level for each pipeline (e.g., Validation 0.43, Staging 0.33; and Operation 0.24, which can be displayed as shown as bars showing the respective confidence levels or by another visualization), and a recommended pipeline (Validation, in this example, which has the highest confidence level). Section 100b includes a display of the modes (manual or automated in this example), a corresponding confidence level for each mode (e.g., Automate 0.82 and Manual 0.18, which can be displayed as shown as a circle that includes the respective confidence levels or by another visualization), and the recommended pipeline (e.g., Automate in this example, which had the highest confidence level).

While one pipeline was selected as the recommended pipeline in the example of FIG. 3, it is noted that more than one pipeline can be selected. For example, two (or more) pipelines with a highest confidence level that are close to equal may be output.

The output 110b can be propagated to a global test management system (GTMS) for the testing.

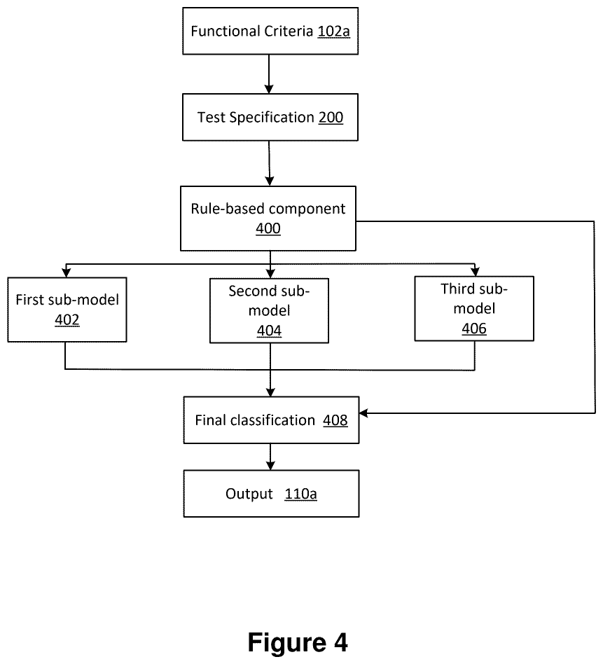

Continuing with the example, the ML model includes a first ML model 108a for the CI pipeline. The first ML model 108a uses an ensemble-based architecture for generating recommendations of CI pipeline. FIG. 4 is a schematic diagram showing an example architecture that includes first ML model 108a. As shown in the example in FIG. 4, the ML model 108a includes a rule-based component 400 along with three sub-models 402, 404, 406. Each sub-model 402, 404, 406 handles a different aspect of the input data 102. The input data 102 to the ensemble model 108a is in the form of a test instruction(s) 200 received (e.g., based on the end user's input as described for FIG. 3). A test instruction can include natural language and categorical data (e.g., artifacts of the test instruction). The rule-based component 400 of the ensemble considers the length of the test instruction(s). First sub-model 402 focuses on capturing the semantic meaning of the test instruction(s). Second sub-model 404 deals with the statistical distribution of words in the test instruction(s). Third sub-model 406 uses the categorical data in the test instruction. The output from each sub-model 402, 404, 406 is used as input to a final classification model 408 in the ensemble, which outputs 110a the final recommendation.

Rule-based component 400 of the first ML model 108a considers the number of characters of each subpart of the test instruction received in the input data 102. A rule assigns test instructions (or a part of a test instruction) to the CI pipeline operation under certain conditions. An example rule provides that if the number of characters in the pre/post-condition section of the example test instruction is greater than 1000, or if the number of characters in the pass criteria section is greater than 800, then the test instruction is assigned to the CI pipeline operation. The rules used in the rule-based component can be derived from analysing a dataset. It is noted that a specific threshold for the rules, and the rules themselves, can vary depending on the analysed dataset and/or the domain.

First sub-model 402 in this example includes a semantic classifier for the CI pipeline. Input to the semantic classifier model 402 in this example includes the four subparts of the test instruction from the example in FIG. 3: test setup, pre/post-conditions, test procedure, and pass criteria, all of which are in natural language form. It is noted that a test instruction(s) can have a different number or type of subparts (e.g., any number of parts/subparts and the parts/subparts can have different categories than those shown in FIG. 3). To capture the semantic and syntactic information of these natural texts, the subparts are converted into word embeddings using pre-trained embeddings (e.g., FastText embeddings, which are 300-dimensional vectors in this example). The embeddings in this example are fed into individual Random Forest classifiers, one for each subpart of the test instruction. Each specific Random Forest classifier employs the Gini impurity as cost function to make predictions for the corresponding subpart. As a result, in this example, the semantic classifier model 402 generates four three-element vectors, one for each subpart, where each element represents the confidence that a test instruction belongs to a certain CI pipeline.

For ease of discussion, examples herein are explained in the non-limiting context of vectors. Moreover, while the example vectors include discussion of a certain number of dimensional vectors, the quantities are examples and different quantities can be used. Additionally, the present disclosure is not limited to use of vectors and embodiments include other representations such as numerical representations.

Second sub-model 404 in this example includes a word-distribution classifier model. Similar to the semantic classifier model 402, in this example, input to the word-distribution classifier model 404 includes the four subparts of the test instruction from the example in FIG. 3: test setup, pre/post-conditions, test procedure, and pass criteria. The word distribution model 404 in this example takes a test instruction as input and outputs four three-element vectors, each representing the probability of the test cases belonging to the three CI pipelines. Each three-element vector is the classification for each part of the test instruction.

In some embodiments, the semantic classification model further generates a confidence level that a respective natural language description per test instruction belongs to the outputted test process.

In some embodiments, the input data further includes the natural language description distributed among a plurality of test instructions, and the word-distribution classification model calculates a probability that a combination of words from the natural language description per respective test instruction belongs to a test process from the plurality of test processes. The input data can further include a plurality of categorical data, the first plurality of sub-models can further include a third sub-model including a categorical data classification model. The categorical data classification model can encode respective categories from the categorical data and output a probability that the respective categories belong to a test process from the plurality of test processes.

In some embodiments, the first ML model concatenates a respective output of the first plurality of sub-models into a numerical representation, and classifies the concatenated numerical representation into the test process from the plurality of test processes to perform the testing.

The following is an overview of a training and classification process of the word-distribution classifier model 404.

During training of the word-distribution classifier model 404, statistics about the training data are collected. The word-distribution classifier model 404 estimates the conditional probability that a specific word occurs given a CI pipeline. It also calculates the distribution of the CI pipelines in the training data. Both the conditional probability of words and the distribution of CI pipelines are calculated and stored separately for each of the four subparts of the test instruction. The distributions are calculated from the training data using the following equations:
a. Estimating the distribution of CI pipelines:

$$P ( CI {pipeline}_{A} ) = \frac{\# CI {pipeline}_{A}}{{\sum }_{CI {pipeline}_{B}}^{[ Validation , Staging , Operation ]} ( \# CI {pipeline}_{B} )} ,$$

$$CI {pipeline}_{A} ∈ [ Validation , Staging , Operation ]$$

b. Estimating the probability of a word in subpart of test instruction given a CI pipeline:

$$P ( Word \vert CI pipeline ) = \frac{\# ( Word \&\& CI pipeline )}{\# CI pipeline} ,$$

$$CI pipeline ∈ [ Validation , Staging , Operation ] , Word ∈ input$$

To classify test instructions in this example, the word-distribution classifier model 404 calculates the conditional probability of a word bag given a particular CI pipeline. The word-distribution classifier model 404 does this by taking the product of all the conditional probabilities for the words in the word bag given the CI pipeline, which were calculated and stored when the word-distribution classifier model 404 was trained. Although this process assumes that the words are independent of each other, which is not always true, the impact of this assumption on the accuracy of the model during testing was negligible.

Continuing with the example, the conditional probability of the word bag given a CI pipeline is calculated for all three CI pipelines. The conditional probability of a CI pipelines given a word bag is then given by the quotient of the conditional probability of the word bag given a test level divided by the sum of the conditional probability of the word bag given a CI pipeline multiplied by the probability of that CI pipeline, where the sum loops through all possible CI pipelines. These three conditional probabilities are the probabilities that the word-distribution classifier model 404 outputs. As a result, the word-distribution classifier model 404 in this example generates four three-element vectors, one for each subpart of the test instruction, where each element represents the confidence that a test instruction belongs to a certain CI pipeline.

If a word that has not been seen during the training phase occurs during prediction, the word-distribution classifier model 404 assigns all probabilities for that word to a very small number. To estimate the probabilities, in this example, the following equations are used:
c. Calculate the probability of a combination of words (word bag) in subpart of test instruction given CI pipeline:

$$P ( Word bag \vert CI pipeline ) = {\prod }_{Word}^{Word bag} P ( Word \vert CI pipeline ) ,$$

$$CI pipeline ∈ [ Validation , Staging , Operation ]$$

d. Calculating the probability of the test instruction to be assigned to CI pipeline A based on the subpart of the test instruction:

$$P ( CI {pipeline}_{A} \vert Word bag ) = \frac{P ( Word bag \vert CI {pipeline}_{A} ) * P ( CI {pipeline}_{A} )}{\begin{matrix}{\sum }_{CI {pipeline}_{B}}^{[ Validation , Staging , Operation ]} ( P ( Word bag \vert CI {pipeline}_{B} ) * \\ P ( CI {pipeline}_{B} ) )\end{matrix}} ,$$

Categorical data classification model 406 in this example leverages the category information 102b provided by the end user in the test instruction to generate recommendations. A one-hot encoder is used in this example to encode the category data 102b. This encoder creates binary columns for each possible value of the category data 102b in the test instruction. In this example, the resulting one-hot encoded category data is then fed into a random forest model that uses the Gini impurity as the cost function for making recommendations. The category data classification model 406 output is a three-element array in this example, where each element represents the probability that the test instruction belongs to each CI pipeline.

Final classification model 408 in this example receives a 27-element vector as input, which is created by concatenating the outputs from the sub-models 402, 404, 406. This concatenated vector is then fed into a ML classifier of final classification model 408. This example uses a random forest with Gini impurity as a cost function. The output of the final classification model 408 is a three-element vector representing the final classification model's 408 confidence in assigning the test instruction to different CI pipelines.

In some embodiments, the ML model includes a second ML model to generate the mode to perform the test process. The second ML model can include a second plurality of sub-models including a fourth sub-model comprising a sematic classification model for the mode, and a fifth sub-model comprising a categorical data classification model for the mode.

The input data can further include the natural language description distributed among a plurality of subparts of a test instruction. The semantic classification model can convert the natural language description distributed among the plurality of subparts of the test instruction into word embeddings, and can output a classification of the natural language description per subpart of the test instruction into the mode.

The semantic classification model can further generate a confidence level that a respective natural language description per subpart of the test instruction belongs to the mode.

In some embodiments, the input data further includes a plurality of categorical data, the ML model includes a first ML model and a second ML model, and the fifth sub-model model (i) receives the plurality of categorical data and an output of the first ML model, (ii) encodes respective categorical data from the plurality of categorical data, (iii) outputs a probability that the respective categorical data belongs to the mode.

The second ML model can receive a concatenated numerical representation of the outputs of the fourth sub-model and the fifth sub-model, and can output the mode and a confidence level for the mode.

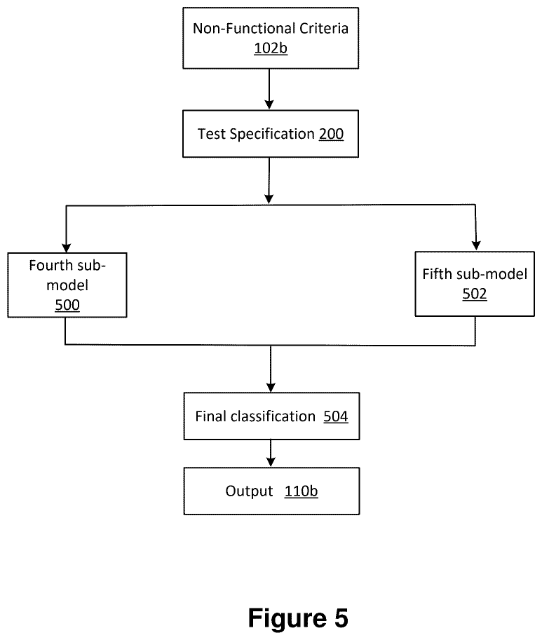

Continuing with the example, the second ML model 108b in this example is used for generating the mode (e.g., manual mode or automate mode). Second ML model 108b in this example uses an example ensemble-based architecture as shown in FIG. 5. The ensemble-based architecture includes two sub-models: fourth sub-model 500 and fifth sub-model 502 that specialize in handling different aspects of the input data 102. The input to the second ML model 108b, in this example, is in the form of test instructions (or subparts of a test instruction) created based on the information provided by the end user in the example in FIG. 3. Fourth sub-model 500 captures the semantic meaning of the test instruction(s) description, while fifth sub-model 502 uses the category data 102b in the test instruction. In this example, a final recommendation is obtained by using the output from each of sub-models 500, 502 as input to the final classification model 504 in the ensemble.

In this example, fourth sub-model 500 includes a sematic classifier model for automation. Semantic classifier model 500 receives a test instruction described in natural language as its input. To capture the underlying meaning of the text, the description is first converted into word embeddings (e.g., using pre-trained FastText embeddings in this example). In this example, these embeddings are then fed into a random forest that utilizes the Gini impurity as the cost function to make predictions about whether the test instruction should be automated or not. The output from the semantic classifier model 500, in this example, is a list with two elements, indicating the level of confidence for automating or not automating the specific test instruction.

The fifth sub-model 502 in this example includes a categorical data classification model. In this example, categorical data classification model 502 uses category data 102b from the test instruction as discussed for the example in FIG. 3, along with the predicted CI pipeline given by first ML model 108a, to generate recommendations for automation. In this example, the data is encoded using a one-hot encoder to transform it into one-hot encoded format. Subsequently, the encoded data is fed into a random forest classifier, which utilizes Gini impurity as the cost function. The output from the random forest classifier is a two-element array, where each element represents the categorical data classification model's 502 confidence level regarding whether a test case should be automated.

Final classification model 504, in this example, receives a 6-element vector as input, which is created by concatenating the outputs from the two sub-models 500, 502. In this example, this concatenated vector is then fed into a support vector machine. The support vector machine in this example has C-SVM as a cost function. The output of the final classification model 504 is a two-element vector representing the second ML model's 108b confidence in whether the test instruction can be automated or not.

In some embodiments, at least a portion of the SUT includes a cloud RAN application; the functional criteria includes a natural language description; the non-functional criteria includes a quality criteria related to the cloud RAN application; the plurality of test processes include a plurality of different test processes for testing at least one of the functional criteria and the non-functional criteria; and the outputting includes the plurality of different test processes, and the mode to perform a respective test process from the plurality of different test processes.

An example of a test management process was evaluated in two ways: (1) for classification of CI pipelines, and (2) for classification of automation.

The following dataset was used for the first evaluation:
Number of test instructions: 487

The performance of the test management process for classifying CI pipelines was evaluated using a dataset of 487 test instructions, with an 80/20 train-test split. The evaluation process was repeated 100 times with different 80/20 train-test splits for reliability, and the average accuracy metrics are calculated as the evaluation results.

Table 2 provides a summary of the performance for the first evaluation:

| Metric | Value |
|---|---|
| F1 score | 0.9163 |
| Accuracy | 0.9233 |
| Recall | 0.9093 |
| Precision | 0.9079 |

The following dataset was used for the second evaluation:
Number of test instructions: 2104

The performance of the test management process for classifying automation was assessed using a dataset of 2104 test instructions, which were divided using an 80/20 train-test split. The evaluation process was repeated 100 times with different 80/20 train-test splits for reliability, and the average accuracy metrics are calculated as the evaluation results.

Table 3 provides a summary of the performance for the second evaluation:

| Metric | Value |
|---|---|
| F1 score | 0.9463 |
| Accuracy | 0.9532 |
| Recall | 0.9424 |
| Precision | 0.9509 |

The results of the evaluation for an example illustrates that the process can result in a reliable tool for decision support based on the process' ability to provide recommendations and confidence ratings for the recommendations. As a consequence, the process may streamline decision-making, while it also may reduce time for making the decisions and providing insight to decision-making that may result in more informed and improved decisions.

Operations discussed herein may provide one or more of the following:
A platform to automatically capture features (e.g., high-level Cloud Ran features
Different test processes (e.g., pipelines) that are compatible with different ISO standards.
Automatic breakdown of a standard (e.g., a new standard) written in a natural text into different CI/CD pipelines.
Automated ISO monitoring in a CI/CD process
Elimination of SME involvement for manually analyzing a standard (e.g., the ISO standards).
Assigning new features to different pipelines considering both functional and non-functional criteria.
Assigning the new features written in controlled or non-controlled natural text to different pipelines.
Detecting and distinguishing functional and non-functional criteria.
Recommendation of test cases for test automation considering:
   functional, non-functional criteria,
   complexity of the feature,
   return on investment,
   the assigned CI/CD pipelines.
Compatibility with automated control systems that have control of operations on a SUT by either an API or GUI interface.
Handling a large set of features requests to be assigned and tested into different CI/CD pipeline (e.g., scalability).
Automatic ability to make decisions without any human involvement for testing a new feature (e.g., a new Cloud RAN feature).

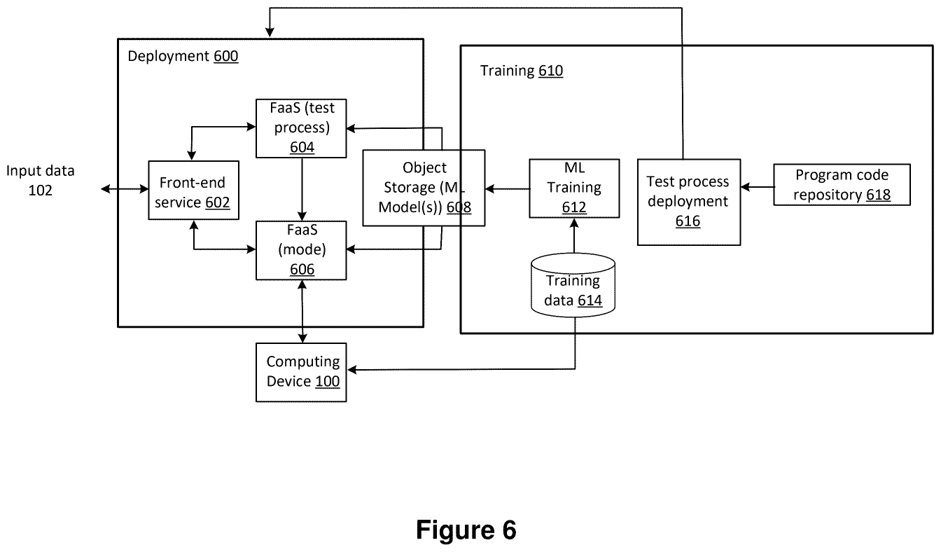

FIG. 6 is a schematic diagram showing an example for cloud implementation for the method. The example cloud implementation includes computing device 100 communicatively connected to a training 610 portion of the cloud implementation, and to a deployment 600 portion of the cloud implementation. The training portion 610 includes ML training 612 of an ML model(s) using training data 614. The trained ML model(s) and/or sub-model(s) are provided to object storage 608. A code repository 618 provides code to CI/CD program 616, which is provided to the deployment portion 600.

Object storage 608 provides the trained ML model(s) and/or sub-model(s) to one or more functions-as-a-service (FaaS) (e.g., a first FaaS 604 for a CI pipeline and a second FaaS 606 for automation as shown in FIG. 6) in the deployment portion 600. Input data 102 is proved to the first and second FaaS 604, 606 via a front-end service 602. Computing device 100 communicates with first and second FaaS 604, 606 regarding operations of the computing device as further described herein. The computing device 100 can include Python.

Technical advantages provided by certain embodiments of the present disclosure may include that based on inclusion in the method of classifying test processes (e.g., CI pipelines), misclassification of test instructions may be reduced, fault-slip through rates may be reduced, SUT quality may be increased, efficiency of assigning test processes (e.g., pipelines) may be increased, and decision-making may be improved based on decreasing vulnerability due to reducing a need for domain expertise.

Moreover, as a consequence, human work and error may be reduced and a SUT or feature of a SUT may be assigned to different test processes considering functional and/or non-functional criteria.

Misclassified test instructions may lead to a delivery delay for a SUT (e.g., software or a feature of software) of two months or more, for example. Assigning a feature, for example, to an incorrect pipeline can directly impact the testing time and, thereby, the delivery date.

Improved assignment of test processes (e.g., CI pipelines), also may reduce fault-slip through rates, which may increase product quality, which may in turn also result in higher customer satisfaction.

Certain embodiments based on the output of the method, the method may enable domain experts to spend less time assigning pipelines, which may lead to more efficient and reduced costs of testing.

Total cost of a testing process may be reduced or minimized, for example, as a consequence of automatic assignment of an SUT or a feature of an SUT to a test process; and/or outputting a test case (or, e.g., a subset of test cases) for automation or not.

Moreover, certain embodiments may simplify decision-making by reducing the domain expertise needed, which also may result in decreased vulnerability to staffing and competence issues.

Further, technical advantages provided by certain embodiments may include that based on classifying the mode (e.g., automation or manual), testing efficiency may be improved and decision-making may be improved based on decreasing vulnerability due to reducing a need for domain expertise.

Testing efficiency may be improved by automating classification of the mode. For example, the classification may increase accuracy of the mode classification. Further, domain experts may spend less time deciding whether a test case should be automated, leading to reduced costs of testing.

Moreover, quality of a product of the SUT (or a feature of the SUT) may be improved through the consideration and monitoring of different standards (e.g., different ISO standards). Operations discussed herein, for example, can capture and adopt changes or modifications in standards (e.g., telecommunications standards).

Decision-making may be improved by automating classification of the mode. For example, dependence on domain experts may be reduced. Further, the method may simplify decision-making by reducing the domain expertise needed, which also may result in lower vulnerability to staffing and competence issues.

Further, recommendation of test cases to automate may maximize a return on investment of test automation.

Further technical advantage's may include optimizing usage of cloud-native infrastructures based on inclusion of outputting of a mode for automated or manual testing.

Moreover, on-time delivery of a SUT, such as a cloud-based application/product, may be improved based on inclusion of assignment of the SUT or features of the SUT to a test process(es) (e.g., pipelines).

Additionally, energy consumption of cloud-native infrastructures may be reduced as a consequence of decreasing a risk of incorrect decisions for the testing.

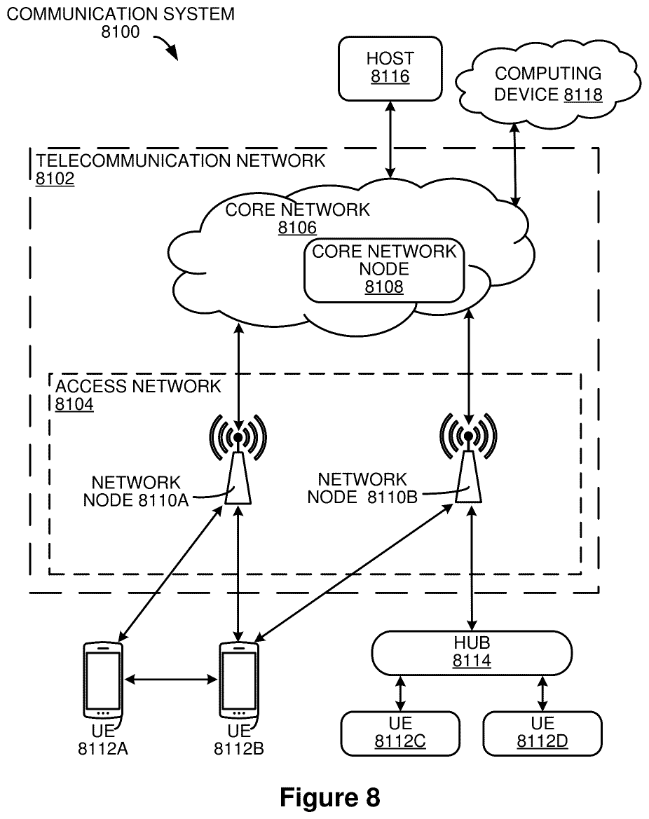

FIG. 8 shows an example of a computing system comprising a communication system 8100 in accordance with some embodiments.

In the example, the communication system 8100 includes a telecommunication network 8102 that includes an access network 8104, such as a RAN, and a core network 8106, which includes one or more core network nodes 8108. The access network 8104 includes one or more access network nodes, such as network nodes 8110a and 8110b (one or more of which may be generally referred to as network nodes 8110), or any other similar 3rd Generation Partnership Project (3GPP) access node or non-3GPP access point. The network nodes 8110 facilitate direct or indirect connection of user equipment (UE), such as by connecting UEs 8112a, 8112b, 8112c, and 8112d (one or more of which may be generally referred to as UEs 8112) to the core network 8106 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 8100 may include any number of wired or wireless networks, network nodes, UEs, and/or any other components or systems that may facilitate or participate in the communication of data and/or signals whether via wired or wireless connections. The communication system 8100 may include and/or interface with any type of communication, telecommunication, data, cellular, radio network, and/or other similar type of system.

The UEs 8112 may be any of a wide variety of communication devices, including wireless devices arranged, configured, and/or operable to communicate wirelessly with the network nodes 8110 and other communication devices. Similarly, the network nodes 8110 are arranged, capable, configured, and/or operable to communicate directly or indirectly with the UEs 8112 and/or with other network nodes or equipment in the telecommunication network 8102 to enable and/or provide network access, such as wireless network access, and/or to perform other functions, such as administration in the telecommunication network 8102.

In the depicted example, the core network 8106 connects the network nodes 8110 to one or more hosts, such as host 8116. These connections may be direct or indirect via one or more intermediary networks or devices. In other examples, network nodes may be directly coupled to hosts. The core network 8106 includes one more core network nodes (e.g., core network node 8108) that are structured with hardware and software components. Features of these components may be substantially similar to those described with respect to the UEs, network nodes, and/or hosts, such that the descriptions thereof are generally applicable to the corresponding components of the core network node 8108. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 8116 may be under the ownership or control of a service provider other than an operator or provider of the access network 8104 and/or the telecommunication network 8102, and may be operated by the service provider or on behalf of the service provider. The host 8116 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 8100 of FIG. 8 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 8102 is a cellular network that implements 3GPP standardized features. Accordingly, the telecommunications network 8102 may support network slicing to provide different logical networks to different devices that are connected to the telecommunication network 8102. For example, the telecommunications network 8102 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 8112 are configured to transmit and/or receive information without direct human interaction. For instance, a UE may be designed to transmit information to the access network 8104 on a predetermined schedule, when triggered by an internal or external event, or in response to requests from the access network 8104. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 8114 communicates with the access network 8104 to facilitate indirect communication between one or more UEs (e.g., UE 8112c and/or 8112d) and network nodes (e.g., network node 8110b). In some examples, the hub 8114 may be a controller, router, content source and analytics, or any of the other communication devices described herein regarding UEs. For example, the hub 8114 may be a broadband router enabling access to the core network 8106 for the UEs. As another example, the hub 8114 may be a controller that sends commands or instructions to one or more actuators in the UEs. Commands or instructions may be received from the UEs, network nodes 8110, or by executable code, script, process, or other instructions in the hub 8114. As another example, the hub 8114 may be a data collector that acts as temporary storage for UE data and, in some embodiments, may perform analysis or other processing of the data. As another example, the hub 8114 may be a content source. For example, for a UE that is a VR headset, display, loudspeaker or other media delivery device, the hub 8114 may retrieve VR assets, video, audio, or other media or data related to sensory information via a network node, which the hub 8114 then provides to the UE either directly, after performing local processing, and/or after adding additional local content. In still another example, the hub 8114 acts as a proxy server or orchestrator for the UEs, in particular if one or more of the UEs are low energy IoT devices.

The hub 8114 may have a constant/persistent or intermittent connection to the network node 8110b. The hub 8114 may also allow for a different communication scheme and/or schedule between the hub 8114 and UEs (e.g., UE 8112c and/or 8112d), and between the hub 8114 and the core network 8106. In other examples, the hub 8114 is connected to the core network 8106 and/or one or more UEs via a wired connection. Moreover, the hub 8114 may be configured to connect to an M2M service provider over the access network 8104 and/or to another UE over a direct connection. In some scenarios, UEs may establish a wireless connection with the network nodes 8110 while still connected via the hub 8114 via a wired or wireless connection. In some embodiments, the hub 8114 may be a dedicated hub—that is, a hub whose primary function is to route communications to/from the UEs from/to the network node 8110b. In other embodiments, the hub 8114 may be a non-dedicated hub—that is, a device which is capable of operating to route communications between the UEs and network node 8110b, but which is additionally capable of operating as a communication start and/or end point for certain data channels.

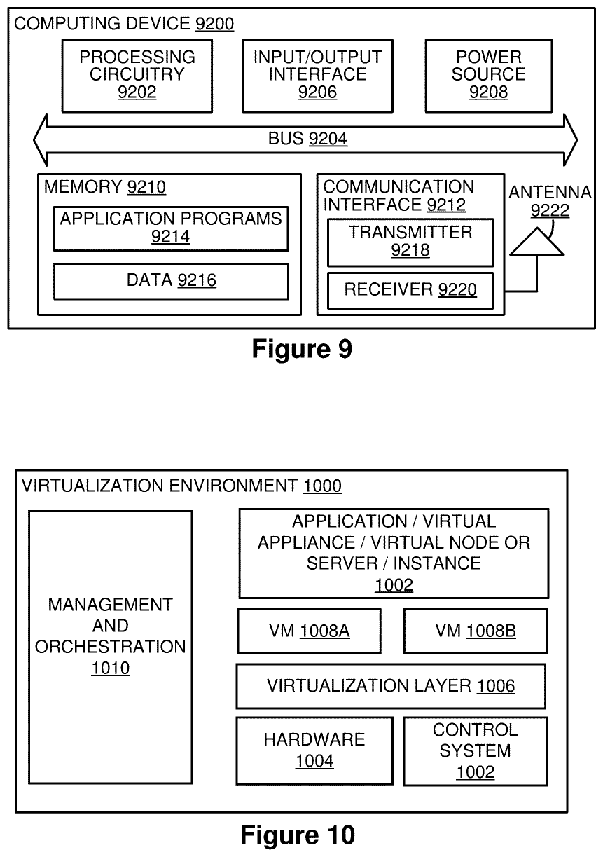

FIG. 9 shows a computing device 9200 (e.g., computing device 100 in FIG. 1 or computing device 8118 in FIG. 8) in accordance with some embodiments. The computing device 9200 includes processing circuitry 9202 that is operatively coupled via a bus 9204 to an input/output interface 9206, a power source 9208, a memory 9210, a communication interface 9212, and/or any other component, or any combination thereof. Certain computing devices may utilize all or a subset of the components shown in FIG. 9. The level of integration between the components may vary from one computing device to another computing device. Further, certain computing devices may contain multiple instances of a component, such as multiple processors, memories, transceivers, transmitters, receivers, etc.

The processing circuitry 9202 is configured to process instructions and data and may be configured to implement any sequential state machine operative to execute instructions stored as machine-readable computer programs in the memory 9210. The processing circuitry 9202 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 9202 may include multiple central processing units (CPUs).

In the example, the input/output interface 9206 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the computing device 9200. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 9208 is structured as a battery or battery pack. Other types of power sources, such as an external power source (e.g., an electricity outlet), photovoltaic device, or power cell, may be used. The power source 9208 may further include power circuitry for delivering power from the power source 9208 itself, and/or an external power source, to the various parts of the computing device 9200 via input circuitry or an interface such as an electrical power cable. Delivering power may be, for example, for charging of the power source 9208. Power circuitry may perform any formatting, converting, or other modification to the power from the power source 9208 to make the power suitable for the respective components of the computing device 9200 to which power is supplied.

The memory 9210 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 9210 includes one or more application programs 9214, such as an operating system, web browser application, a widget, gadget engine, or other application, and corresponding data 9216. The memory 9210 may store, for use by the computing device 9200, any of a variety of various operating systems or combinations of operating systems.

The memory 9210 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 9210 may allow the computing device 9200 to access instructions, application programs and the like, stored on transitory or non-transitory memory media, to off-load data, or to upload data. An article of manufacture, such as one utilizing a communication system may be tangibly embodied as or in the memory 9210, which may be or comprise a device-readable storage medium.

The processing circuitry 9202 may be configured to communicate in a computing/computerized system (e.g., including, without limitation with an access network or other network) using the communication interface 9212. The communication interface 9212 may comprise one or more communication subsystems and may optionally include or be communicatively coupled to an antenna 9222. The communication interface 9212 may include one or more transceivers used to communicate, such as by communicating with one or more remote transceivers of another device capable of wireless communication (e.g., another computing device or a node in a computing/computerized system). Each transceiver may include a transmitter 9218 and/or a receiver 9220 appropriate to provide network communications (e.g., optical, electrical, frequency allocations, and so forth). Moreover, the transmitter 9218 and receiver 9220 may be coupled to one or more antennas (e.g., antenna 9222) and may share circuit components, software or firmware, or alternatively be implemented separately.

In the illustrated embodiment, communication functions of the communication interface 9212 may include communications in a computing/computerized system, cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof.

Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

In practice, any number of computing devices may be used together with respect to a single use case. For example, a first computing device might be or be integrated in a computing/computerized system to provide a test process to a second computing device that provides the mode. The first and/or the second computing device can also include more than one of the functionalities described above.

FIG. 10 is a block diagram illustrating a virtualization environment 1000 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1000 hosted by one or more of hardware nodes, such as a hardware computing device that operates as a computing device. Further, in embodiments in which the virtual node does not require radio connectivity (e.g., a computing node comprising a server), then the computing device may be entirely virtualized.

Applications 1002 (which may alternatively be called software instances, virtual appliances, network functions, virtual nodes, virtual network functions, etc.) are run in the virtualization environment to implement some of the features, functions, and/or benefits of some of the embodiments disclosed herein.

Hardware 1004 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1006 (also referred to as hypervisors or virtual machine monitors (VMMs)), provide VMs 1008a and 1008b (one or more of which may be generally referred to as VMs 1008), and/or perform any of the functions, features and/or benefits described in relation with some embodiments described herein. The virtualization layer 1006 may present a virtual operating platform that appears like networking hardware to the VMs 1008.

The VMs 1008 comprise virtual processing, virtual memory, virtual networking or interface and virtual storage, and may be run by a corresponding virtualization layer 1006. Different embodiments of the instance of a virtual appliance 1002 may be implemented on one or more of VMs 1008, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 1008 may be a software implementation of a physical machine that runs programs as if they were executing on a physical, non-virtualized machine. Each of the VMs 1008, and that part of hardware 1004 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1008 on top of the hardware 1004 and corresponds to the application 1002.

Hardware 1004 may be implemented in a standalone network node with generic or specific components. Hardware 1004 may implement some functions via virtualization. Alternatively, hardware 1004 may be part of a larger cluster of hardware (e.g. such as in a data center or CPE) where many hardware nodes work together and are managed via management and orchestration 1010, which, among others, oversees lifecycle management of applications 1002. In some embodiments, hardware 1004 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station.

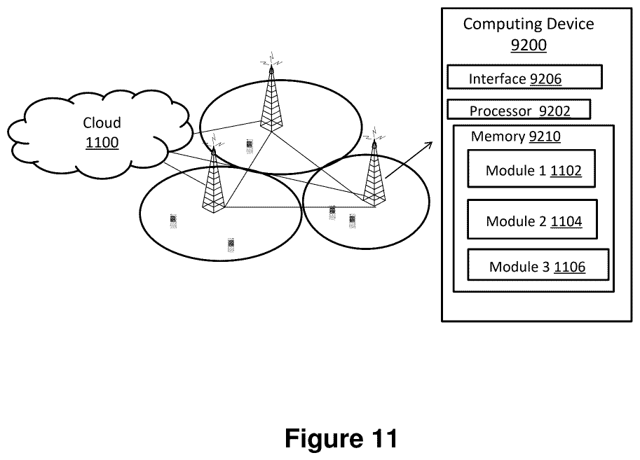

Referring to FIG. 11, computing device 9200 may, in some embodiments, be an electronic device that can be communicatively connected to other electronic devices on the network (e.g., other computing devices, etc.). In certain embodiments, computing device 9200 may include radio access features that provide wireless radio network access to other electronic devices (for example a “radio access computing device” may refer to such a computing device) such as UEs. As depicted in FIG. 11, the example computing device 9200 comprises processor 9202, memory 9210, interface 9206, and antenna 17104. These components may work together to provide various computing device functionality as disclosed herein.

Processor 9202 may be a microprocessor, controller, microcontroller, central processing unit, digital signal processor, application specific integrated circuit, field programmable gate array, any other type of electronic circuitry, or any combination of one or more of the preceding. The processor 9202 may comprise one or more processor cores. In particular embodiments, some or all of the functionality described herein as being provided by computing device 9200 may be implemented by processor 9202 executing software instructions, either alone or in conjunction with other computing device 9200 components, such as memory 9210.

Memory 9210 may store code (which is composed of software instructions and which is sometimes referred to as computer program code or a computer program) and/or data using non-transitory machine-readable (e.g., computer-readable) media, such as machine-readable storage media (e.g., magnetic disks, optical disks, solid state drives, read only memory (ROM), flash memory devices, phase change memory) and machine-readable transmission media (e.g., electrical, optical, radio, acoustical or other form of propagated signals—such as carrier waves, infrared signals). For instance, memory 9210 may comprise non-volatile memory containing code to be executed by processor 9202. Where memory 9210 is non-volatile, the code and/or data stored therein can persist even when the computing device is turned off (when power is removed). In some instances, while computing device 9200 is turned on that part of the code that is to be executed by the processor(s) 9202 may be copied from non-volatile memory into volatile memory (e.g., dynamic random access memory (DRAM), static random access memory (SRAM)) of computing device 9200.

Interface 9206 may be used in the wired and/or wireless communication of signaling and/or data to or from computing device 9200. For example, interface 9206 may perform any formatting, coding, or translating to allow computing device 9200 to send and receive data whether over a wired and/or a wireless connection. In some embodiments, interface 9206 may comprise radio circuitry capable of receiving data from other devices in the network over a wireless connection and/or sending data out to other devices via a wireless connection. This radio circuitry may include transmitter(s), receiver(s), and/or transceiver(s) suitable for radiofrequency communication. The radio circuitry may convert digital data into a radio signal having the appropriate parameters (e.g., frequency, timing, channel, bandwidth, etc.). The radio signal may then be transmitted via antennas to the appropriate recipient(s). In some embodiments, interface 9206 may comprise network interface controller(s) (NICs), also known as a network interface card, network adapter, local area network (LAN) adapter or physical network interface. The NIC(s) may facilitate connecting the computing device 9200 to other devices allowing them to communicate via wire through plugging in a cable to a physical port connected to a NIC. As explained above, in particular embodiments, processor 9202 may represent part of interface 9206, and some or all of the functionality described as being provided by interface X103 may be provided more specifically by processor 9202.

The components of computing device 9200 are each depicted as separate boxes located within a single larger box for reasons of simplicity in describing certain aspects and features of computing device 9200 disclosed herein. In practice however, one or more of the components illustrated in the example computing device 9200 may comprise multiple different physical elements (e.g., interface 9206 may comprise terminals for coupling wires for a wired connection and a radio transceiver for a wireless connection).

Methods of the present disclosure solution described herein may thus be implemented in the computing device 9200 by means of a computer program comprising instructions which, when executed on at least one processor, cause the at least one processor to carry out the actions according to any of the above features and embodiments, where appropriate.

While the modules are illustrated as being implemented in software stored in memory 9210, other embodiments implement part or all of each of these modules in hardware.

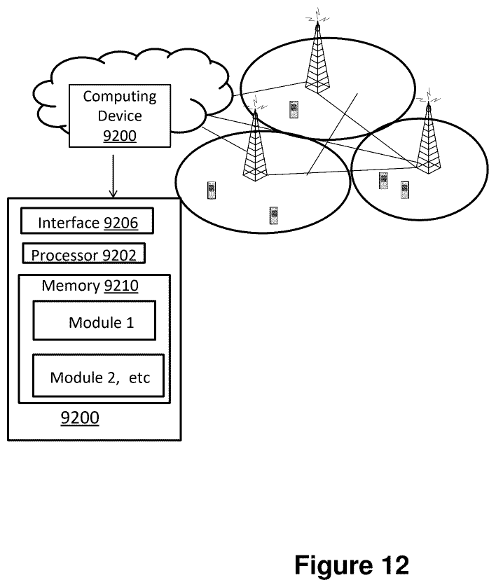

FIG. 12 is a schematic diagram illustrating an implementation of a computing device 9200 in the cloud. For example, computing device 9200 may be a server, a distributed base station, a site data collection node, a synchronization feature assessment node, and/or a node for a target deployment. As depicted in an, the example computing device 9200 comprises processor 9200, memory 9210, interface 9206, and an antenna (not shown in FIG. 12). These components may work together to provide various computing device functionality as disclosed herein.

Processor 9200 may be a microprocessor, controller, microcontroller, central processing unit, digital signal processor, application specific integrated circuit, field programmable gate array, any other type of electronic circuitry, or any combination of one or more of the preceding. The processor 9200 may comprise one or more processor cores. In particular embodiments, some or all of the functionality described herein as being provided by computing device 9200 may be implemented by processor 9200 executing software instructions, either alone or in conjunction with other computing device 9200 components, such as memory 9210.

Memory 9210 may store code (which is composed of software instructions and which is sometimes referred to as computer program code or a computer program) and/or data using non-transitory machine-readable (e.g., computer-readable) media, such as machine-readable storage media (e.g., magnetic disks, optical disks, solid state drives, read only memory (ROM), flash memory devices, phase change memory) and machine-readable transmission media (e.g., electrical, optical, radio, acoustical or other form of propagated signals-such as carrier waves, infrared signals). For instance, memory 9210 may comprise non-volatile memory containing code to be executed by processor 9200. Where memory 9210 is non-volatile, the code and/or data stored therein can persist even when the computing device is turned off (when power is removed). In some instances, while computing device 9200 is turned on that part of the code that is to be executed by the processor(s) 9200 may be copied from non-volatile memory into volatile memory (e.g., dynamic random access memory (DRAM), static random access memory (SRAM)) of computing device 9200.

Interface 9206 may be used in the wired and/or wireless communication of signaling and/or data to or from computing device 9200. For example, interface 9206 may perform any formatting, coding, or translating to allow computing device 9200 to send and receive data whether over a wired and/or a wireless connection. In some embodiments, interface 9206 may comprise radio circuitry capable of receiving data from other devices in the network over a wireless connection and/or sending data out to other devices via a wireless connection. This radio circuitry may include transmitter(s), receiver(s), and/or transceiver(s) suitable for radiofrequency communication. The radio circuitry may convert digital data into a radio signal having the appropriate parameters (e.g., frequency, timing, channel, bandwidth, etc.). The radio signal may then be transmitted via antennas 18104 to the appropriate recipient(s). In some embodiments, interface 9206 may comprise network interface controller(s) (NICs), also known as a network interface card, network adapter, local area network (LAN) adapter or physical network interface. The NIC(s) may facilitate connecting the computing device 9200 to other devices allowing them to communicate via wire through plugging in a cable to a physical port connected to a NIC. As explained above, in particular embodiments, processor 9200 may represent part of interface 9206, and some or all of the functionality described as being provided by an interface may be provided more specifically by processor 9200.

The components of computing device 9200 are each depicted as separate boxes located within a single larger box for reasons of simplicity in describing certain aspects and features of computing device 9200 disclosed herein. In practice however, one or more of the components illustrated in the example computing device 9200 may comprise multiple different physical elements (e.g., interface 9206 may comprise an over the air interface).

Methods of the present disclosure solution described herein may thus be implemented in the computing device 9200 by means of a computer program comprising instructions which, when executed on at least one processor, cause the at least one processor to carry out the actions according to any of the above features and embodiments, where appropriate.

While the modules are illustrated as being implemented in software stored in memory 9210, other embodiments implement part or all of each of these modules in hardware.

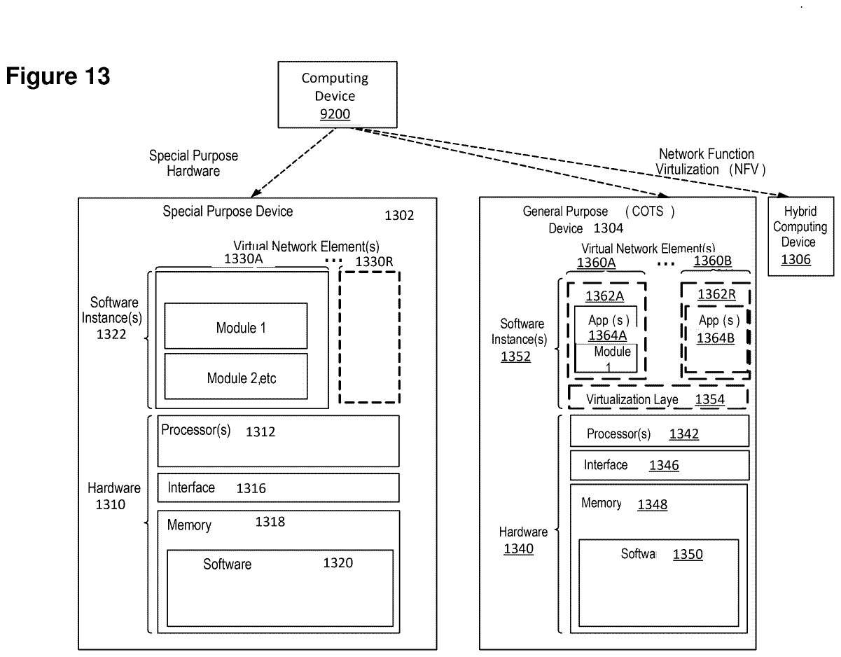

FIG. 13 illustrates two specific examples of how computing device 9200 may be implemented in certain embodiments of the present disclosure including: 1) a special-purpose computing device 1302 that uses custom processing circuits such as application-specific integrated-circuits (ASICs) and a proprietary operating system (OS); and 2) a general purpose computing device 1304 that uses common off-the-shelf (COTS) processors and a standard OS which has been configured to provide one or more of the features or functions disclosed herein.

Special-purpose computing device 1302 includes hardware 1310 comprising processor(s) 1312, and interface 1316, as well as memory 1318 having stored therein software 1320. In one embodiment, the software 1320 implements the modules described with regard to the previous figures. During operation, the software 1320 may be executed by the hardware 1310 to instantiate a set of one or more software instance(s) 1322. Each of the software instance(s) 1322, and that part of the hardware 1310 that executes that software instance (be it hardware dedicated to that software instance, hardware in which a portion of available physical resources (e.g., a processor core) is used, and/or time slices of hardware temporally shared by that software instance with others of the software instance(s) 1322), form a separate virtual network element 1330A-R. Thus, in the case where there are multiple virtual network elements 1330A-R, each operates as one of the computing devices from the preceding figures.

The example general purpose computing device 1304 includes hardware 1340 comprising a set of one or more processor(s) 1342 (which are often COTS processors) and interface 1346, as well as memory 1348 having stored therein software 1350. During operation, the processor(s) 1342 execute the software 1350 to instantiate one or more sets of one or more applications 1364A-R. While certain embodiments do not implement virtualization, alternative embodiments may use different forms of virtualization. For example, in certain alternative embodiments virtualization layer 1354 represents the kernel of an operating system (or a shim executing on a base operating system) that allows for the creation of multiple instances 1362A-R called software containers that may each be used to execute one (or more) of the sets of applications 1364A-R. In this embodiment, software containers 1362A-R (also called virtualization engines, virtual private servers, or jails) are user spaces (typically a virtual memory space) that may be separate from each other and separate from the kernel space in which the operating system is run. In certain embodiments, the set of applications running in a given user space, unless explicitly allowed, may be prevented from accessing the memory of the other processes. In other such alternative embodiments virtualization layer 1354 may represent a hypervisor (sometimes referred to as a virtual machine monitor (VMM)) or a hypervisor executing on top of a host operating system; and each of the sets of applications 1364A-R may run on top of a guest operating system within an instance 1362A-R called a virtual machine (which in some cases may be considered a tightly isolated form of software container that is run by the hypervisor). In certain embodiments, one, some or all of the applications are implemented as unikernel(s), which can be generated by compiling directly with an application only a limited set of libraries (e.g., from a library operating system (LibOS) including drivers/libraries of OS services) that provide the particular OS services needed by the application. As a unikernel can be implemented to run directly on hardware 1340, directly on a hypervisor (in which case the unikernel is sometimes described as running within a LibOS virtual machine), or in a software container, embodiments can be implemented fully with unikernels running directly on a hypervisor represented by virtualization layer 1354, unikernels running within software containers represented by instances 1362A-R, or as a combination of unikernels and the above-described techniques (e.g., unikernels and virtual machines both run directly on a hypervisor, unikernels and sets of applications that are run in different software containers).

The instantiation of the one or more sets of one or more applications 1364A-R, as well as virtualization if implemented are collectively referred to as software instance(s) 1352. Each set of applications 1364A-R, corresponding virtualization construct (e.g., instance 1362A-R) if implemented, and that part of the hardware 1340 that executes them (be it hardware dedicated to that execution and/or time slices of hardware temporally shared by software containers 1362A-R), forms a separate virtual network element(s) 1360A-R.

The virtual network element(s) 1360A-R perform similar functionality to the virtual network element(s) 1330A-R. This virtualization of the hardware 1340 is sometimes referred to as network function virtualization (NFV)). Thus, NFV may be used to consolidate many network equipment types onto industry standard high volume server hardware, physical switches, and physical storage, which could be located in for example data centers and customer premise equipment (CPE). However, different embodiments of the invention may implement one or more of the software container(s) 1362A-R differently. While embodiments of the invention are illustrated with each instance 1362A-R corresponding to one VNE 1360A-R, alternative embodiments may implement this correspondence at a finer level granularity; it should be understood that the techniques described herein with reference to a correspondence of instances 1362A-R to VNEs also apply to embodiments where such a finer level of granularity and/or unikernels are used.

The third exemplary computing device implementation in FIG. 13 is a hybrid computing device 1306, which includes both custom ASICs/proprietary OS and COTS processors/standard OS in a single ND or a single card within an ND. In certain embodiments of such a hybrid computing device, a platform virtual machine (VM), such as a VM that that implements the functionality of the special-purpose computing device 1302, could provide for para-virtualization to the hardware present in the hybrid computing device 1306.

Although the computing devices described herein may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a computing/computerized network generally.

Further definitions and embodiments are discussed below.

In the above-description of various embodiments of present inventive concepts, it is to be understood that the terminology used herein is for the purpose of describing particular embodiments only and is not intended to be limiting of present inventive concepts. Unless otherwise defined, all terms (including technical and scientific terms) used herein have the same meaning as commonly understood by one of ordinary skill in the art to which present inventive concepts belong. It will be further understood that terms, such as those defined in commonly used dictionaries, should be interpreted as having a meaning that is consistent with their meaning in the context of this specification and the relevant art and will not be interpreted in an idealized or overly formal sense unless expressly so defined herein.

When an element is referred to as being “connected”, “coupled”, “responsive”, or variants thereof to another element, it can be directly connected, coupled, or responsive to the other element or intervening elements may be present. In contrast, when an element is referred to as being “directly connected”, “directly coupled”, “directly responsive”, or variants thereof to another element, there are no intervening elements present. Like numbers refer to like elements throughout. Furthermore, “coupled”, “connected”, “responsive”, or variants thereof as used herein may include wirelessly coupled, connected, or responsive. As used herein, the singular forms “a”, “an” and “the” are intended to include the plural forms as well, unless the context clearly indicates otherwise. Well-known functions or constructions may not be described in detail for brevity and/or clarity. The term “and/or” (abbreviated “/”) includes any and all combinations of one or more of the associated listed items.

It will be understood that although the terms first, second, third, etc. may be used herein to describe various elements/operations, these elements/operations should not be limited by these terms. These terms are only used to distinguish one element/operation from another element/operation. Thus a first element/operation in some embodiments could be termed a second element/operation in other embodiments without departing from the teachings of present inventive concepts. The same reference numerals or the same reference designators denote the same or similar elements throughout the specification.

As used herein, the terms “comprise”, “comprising”, “comprises”, “include”, “including”, “includes”, “have”, “has”, “having”, or variants thereof are open-ended, and include one or more stated features, integers, elements, steps, components or functions but does not preclude the presence or addition of one or more other features, integers, elements, steps, components, functions or groups thereof. Furthermore, as used herein, the common abbreviation “e.g.”, which derives from the Latin phrase “exempli gratia,” may be used to introduce or specify a general example or examples of a previously mentioned item, and is not intended to be limiting of such item. The common abbreviation “i.e.”, which derives from the Latin phrase “id est,” may be used to specify a particular item from a more general recitation.

Example embodiments are described herein with reference to block diagrams and/or flowchart illustrations of computer-implemented methods, apparatus (systems and/or devices) and/or computer program products. It is understood that a block of the block diagrams and/or flowchart illustrations, and combinations of blocks in the block diagrams and/or flowchart illustrations, can be implemented by computer program instructions that are performed by one or more computer circuits. These computer program instructions may be provided to a processor circuit of a general purpose computer circuit, special purpose computer circuit, and/or other programmable data processing circuit to produce a machine, such that the instructions, which execute via the processor of the computer and/or other programmable data processing apparatus, transform and control transistors, values stored in memory locations, and other hardware components within such circuitry to implement the functions/acts specified in the block diagrams and/or flowchart block or blocks, and thereby create means (functionality) and/or structure for implementing the functions/acts specified in the block diagrams and/or flowchart block(s).

These computer program instructions may also be stored in a tangible computer-readable medium that can direct a computer or other programmable data processing apparatus to function in a particular manner, such that the instructions stored in the computer-readable medium produce an article of manufacture including instructions which implement the functions/acts specified in the block diagrams and/or flowchart block or blocks. Accordingly, embodiments of present inventive concepts may be embodied in hardware and/or in software (including firmware, resident software, micro-code, etc.) that runs on a processor such as a digital signal processor, which may collectively be referred to as “circuitry,” “a module” or variants thereof.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated. Finally, other blocks may be added/inserted between the blocks that are illustrated, and/or blocks/operations may be omitted without departing from the scope of inventive concepts. Moreover, although some of the diagrams include arrows on communication paths to show a primary direction of communication, it is to be understood that communication may occur in the opposite direction to the depicted arrows.

Many variations and modifications can be made to the embodiments without substantially departing from the principles of the present inventive concepts. All such variations and modifications are intended to be included herein within the scope of present inventive concepts. Accordingly, the above disclosed subject matter is to be considered illustrative, and not restrictive, and the examples of embodiments are intended to cover all such modifications, enhancements, and other embodiments, which fall within the spirit and scope of present inventive concepts. Thus, to the maximum extent allowed by law, the scope of present inventive concepts are to be determined by the broadest permissible interpretation of the present disclosure including the examples of embodiments and their equivalents, and shall not be restricted or limited by the foregoing detailed description.

1. A computer-implemented method for management of a testing process in a computing system, the method comprising:
receiving input data comprising a natural language description for testing of at least one of a functional criteria and a non-functional criteria related to at least a portion of a system under test;
based on the input data, generating with a machine learning, ML, model, at least one of (i) a test process from a plurality of testing processes to perform the testing, and (ii) a mode to perform the test process comprising at least one of automated testing and manual testing; and
outputting, from the ML model, at least one of (i) the test process to perform the testing, and (ii) the mode to perform the test process,
wherein the functional criteria comprises at least one of a description of a function of at least the portion of the system under test, and a feature of at least the portion of the system under test; and
wherein the non-functional criteria comprises at least one of a quality attribute related to at least the portion of the system under test.

2-3. (canceled)

4. The method of claim 1, wherein the test process comprises a pipeline and the plurality of testing processes comprise a plurality of different pipelines comprising a validation pipeline, a staging pipeline, and an operations pipeline.

5. The method of claim 1, wherein the test process comprises at least a subset of the plurality of testing processes, and a respective test process from the subset is generated and output for respective functional criteria or non-functional criteria.

6. The method of claim 1, wherein the generating comprises using the ML model to analyze semantics of at least the natural language description to classify a test process, and to determine a statistical distribution of words in the natural language description to identify the test process.

7. The method of claim 1, wherein the ML model comprises a first ML model comprising a rule-based component to analyze a length of the natural language description, and a first plurality of sub-models to generate the test process,
wherein the first plurality of sub-models comprises a first sub-model comprising a semantic classification model to output a semantic meaning of the natural language description,
a second sub-model comprising a word-distribution classification model to output a statistical distribution of words in the natural language description, and
wherein the first ML model receives at least the output of the semantic classification model and the word-distribution classification model to classify and output the test process.

8. The method of claim 7, wherein the rule-based component determines a number of characters in the natural language description and uses a plurality of rules to assign the natural language description to a test process based on the number of characters.

9. The method of claim 7, wherein the input data further comprises the natural language description distributed among a plurality of test instructions, and
the semantic classification model converts the natural language description distributed among the plurality of test instructions to word embeddings, and outputs a classification of the natural language description per test instruction into an outputted test process from the plurality of test processes.

10. The method of claim 9, wherein the semantic classification model further generates a confidence level that a respective natural language description per test instruction belongs to the outputted test process.

11. The method of claim 7, wherein the input data further comprises the natural language description distributed among a plurality of test instructions, and the word-distribution classification model calculates a probability that a combination of words from the natural language description per respective test instruction belongs to a test process from the plurality of test processes.

12. The method of claim 7, wherein the input data further comprises a plurality of categorical data, the first plurality of sub-models further comprises a third sub-model comprising a categorical data classification model, and
the categorical data classification model encodes respective categories from the categorical data and outputs a probability that the respective categories belong to a test process from the plurality of test processes.

13. The method of claim 7, wherein the first ML model concatenates a respective output of the first plurality of sub-models into a numerical representation, and classifies the concatenated numerical representation into the test process from the plurality of test processes to perform the testing.

14. The method of claim 1, wherein the ML model comprises a second ML model to generate the mode to perform the test process.

15. The method of claim 14, wherein the second ML model comprises a second plurality of sub-models comprising a fourth sub-model comprising a sematic classification model for the mode, and a fifth sub-model comprising a categorical data classification model for the mode.

16. The method of claim 15, wherein the input data further comprises the natural language description distributed among a plurality of subparts of a test instruction, and
the semantic classification model converts the natural language description distributed among the plurality of subparts of the test instruction into word embeddings, and outputs a classification of the natural language description per subpart of the test instruction into the mode.

17. The method of claim 16, wherein the semantic classification model further generates a confidence level that a respective natural language description per subpart of the test instruction belongs to the mode.

18. The method of claim 15, wherein the input data further comprises a plurality of categorical data and the ML model comprises a first ML model and a second ML model, and
wherein the fifth sub-model model (i) receives the plurality of categorical data and an output of the first ML model, (ii) encodes respective categorical data from the plurality of categorical data, and (iii) outputs a probability that the respective categorical data belongs to the mode.

19. The method of claim 18, wherein the second ML model receives a concatenated numerical representation of the outputs of the fourth sub-model and the fifth sub-model, and outputs the mode and a confidence level for the mode.

20. The method of claim 1, further comprising:
displaying at least one of the test process to perform the testing, and the mode to perform the testing,
wherein the displaying further comprises displaying a first confidence level for the test process and a second confidence level for the mode.

21. (canceled)

22. The method of claim 1, wherein
the at least a portion of the system under test comprises a cloud radio access network, RAN, application,
the functional criteria comprises the natural language description,
the non-functional criteria comprises a quality criteria related to the cloud RAN application,
the plurality of test processes comprise a plurality of different test processes for testing at least one of the functional criteria and the non-functional criteria, and
the outputting comprises the plurality of different test processes, and the mode to perform a respective test process from the plurality of different test processes.

23. A computing device for managing a testing process in a computing system, the computing device comprising:
processing circuitry;
memory coupled with the processing circuitry, wherein the memory includes instructions that when executed by the processing circuitry causes the computing device to perform operations comprising:
receive input data comprising a natural language description for testing of at least one of a functional criteria and a non-functional criteria related to at least a portion of a system under test;
based on the input data, generate with a machine learning, ML, model, at least one of (i) a test process from a plurality of testing processes to perform the testing, and (ii) a mode to perform the test process comprising at least one of automated testing and manual testing; and
output, from the ML model, at least one of (i) the test process to perform the testing, and (ii) the mode to perform the test process.

24-30. (canceled)
